(19) United States
(12) Patent Application Publication
(10) Pub. No.: US 2012/0276991 A1
(43) Pub. Date: Nov. 1, 2012

(54) Interactive Entertainment and Competition System with Cause-Based Reward System

(76) Inventors: Nathan Eaans, Los Angeles, CA (US); Jan Lindner, Venlce, CA (US); David Michail, Big Bear City, CA (US)

(21) Appl. No.: 13/462,770

(22) Filed: May 2, 2012

Related U.S. Application Data
(63) Continuation of application No. 12/539,600, filed on Aug. 11, 2009.
(60) Provisional application No. 61/087,978, filed on Aug. 11, 2008.

(51) Int. Cl. A63F 13/00

(52) U.S. Cl. 463/30

(57) ABSTRACT

Disclosed is a method for creating a motion picture using a real-time game system that includes receiving a plurality of inputs from participants in the real-time game system; storing the plurality of inputs in a time-based manner; and generating a plurality of video frames based on the time-based storage of the plurality of inputs. An apparatus for performing the method is also disclosed.

### CROSS-REFERENCE TO RELATED APPLICATIONS

Claim of Priority under 35 U.S.C. §119

The present Application for Patent claims priority to Provisional Application No. 61/087,978, entitled “INTERACTIVE ENTERTAINMENT AND COMPETITION SYSTEM WITH CAUSED-BASED REWARD SYSTEM” filed Aug. 11, 2008, and assigned to the assignee hereof and hereby expressly incorporated by reference herein.

### BACKGROUND

1. Field

The following description relates generally to interactive entertainment and online gaming systems that integrates both online and live, in-person group event components.

2. Background of the Invention

The recent convergence of interactive gaming and film has provided many examples of movies derived from interactive gaming intellectual property and vice versa. While the two art forms are often converging in terms of their visuals and plot developments, any example of a genre crossover at this junction is merely a case of the separate production of a film and an interactive game based on some shared art and plot elements. The goal of this proposed competition system is to directly link an interactive game and a movie in such a manner that the theatrical presentation of the movie can be directly influenced by play within the interactive universe in a manner that allows to generate parts of the movie in real time (or close to real time) directly from data derived through game play.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to various aspects, the subject innovation relates to systems and/or methods that provide an interactive entertainment and competition system, where an apparatus for creating a motion picture using a real-time game system includes a processing system configured to construct a receiving a plurality of inputs from participants in the real-time game system; storing the plurality of inputs in a time-based manner; and generating a plurality of video frames based on the time-based storage of the plurality of inputs.

In another aspect, a method for creating a motion picture using a real-time game system includes receiving a plurality of inputs from participants in the real-time game system; storing the plurality of inputs in a time-based manner; and generating a plurality of video frames based on the time-based storage of the plurality of inputs.

In yet another aspect, an apparatus for creating a motion picture using a real-time game system includes means for receiving a plurality of inputs from participants in the real-time game system; means for storing the plurality of inputs in a time-based manner; and means for generating a plurality of video frames based on the time-based storage of the plurality of inputs.

In yet another aspect, a computer program product for creating a motion picture using a real-time game system, includes a computer-readable medium. The computer-readable medium includes code for receiving a plurality of inputs from participants in the real-time game system; code for storing the plurality of inputs in a time-based manner; and code for generating a plurality of video frames based on the time-based storage of the plurality of inputs.

To the accomplishment of the foregoing and related ends, the one or more aspects comprise the features hereinafter fully described and particularly pointed out in the claims. The following description and the annexed drawings set forth in detail certain illustrative aspects of the one or more aspects. These aspects are indicative, however, of but a few of the various ways in which the principles of various aspects may be employed and the described aspects are intended to include all such aspects and their equivalents.

### BRIEF DESCRIPTION OF THE DRAWINGS

FIG. 1 is a diagram illustrating an interactive entertainment system that integrates both online and live, in-person group event components, configured in accordance with one desired approach;

FIG. 2 is a relationship diagram illustrating the relationships between the various entities of the interactive entertainment system of FIG. 1;

FIG. 3 is a block diagram illustrating the various aspects of the interactive entertainment system of FIG. 3;

FIG. 4 is a block diagram of a computer system usable in the interactive entertainment system of FIG. 3; and

FIG. 5 is a flow diagram of a computer algorithm usable for implementing the computer system in the interactive entertainment system of FIG. 3.

### DETAILED DESCRIPTION

What is described herein is a fully integrated interactive entertainment system providing a true interactive entertainment experience by having live audience interaction with a dynamic narrative, or story. In one exemplary embodiment, the term narrative is used to depict a story within all digital distributed media, including, without limitation, motion picture, television, Web, mobile, or any other media devised in the future. When a narrative is “fixed” the story conventions are set and the audience has no participation in the sequence of events or outcomes. In the dynamic narrative supported by the interactive entertainment system described herein, the audience has the ability to participate to some extent in the outcomes or sequence of events. In an exemplary approach, members of the audience interact with the narrative through a Massive Multi-player Online Game (MMOG) system. The interaction from the audience provides user-generated content with the MMOG acting as a point of integration and affects the dynamic narrative. For example, the user interaction creates text logs of user interaction with the MMOG, computer-generated images (CGI) such as computer-rendered three-dimensional images and can also include live action superimposed thereon. The completed production is then distributed via broadcast and other means. In an exemplary approach, the point of broadcast distribution of the dynamic narrative could be to theatrical, Internet Protocol Television (IPTV) (system for delivering digital content over an Internet Protocol network such as the Internet), streaming media, satellite/cable, broadcast television, and mobile outlets.

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

The word “exemplary” is used herein to mean “serving as an example, instance, or illustration.” Any aspect described herein as “exemplary” is not necessarily to be construed as preferred or advantageous over other aspects.

The present embodiment addresses the failure of the traditional approaches to make motion picture and television an immersive audience experience. The MMOG platform is used as the optimum vehicle for the input mechanism required to produce the paradigm of a new immersive entertainment experience. Essentially, the two types of distinct entertainment approaches have been merged into a hybrid system whereby the MMOG integrates into the long-form narratives of traditional media and the traditional long-form narrative is guided, in part, by the actions of the MMOG participants threading through a dynamic story line that is determinative for the competitive gaming environment.

Essentially, the narrative is created based on two user-interactive components: (1) game play through the MMOG, and (2) game play at what shall be referred to as “live narrative events”, the end result of which can be distributed in a theatrical, television, IPTV, web, gaming console, mobile, or any other type of distribution vehicle. The game play on the MMOG will generally be performed individually by the users on their own computers. During the live narrative events, a live action or CGI film, or television, web or mobile episode (or through any other type of media) can be integrated with live game play in real time and then buffered and streamed to a general audience for distribution.

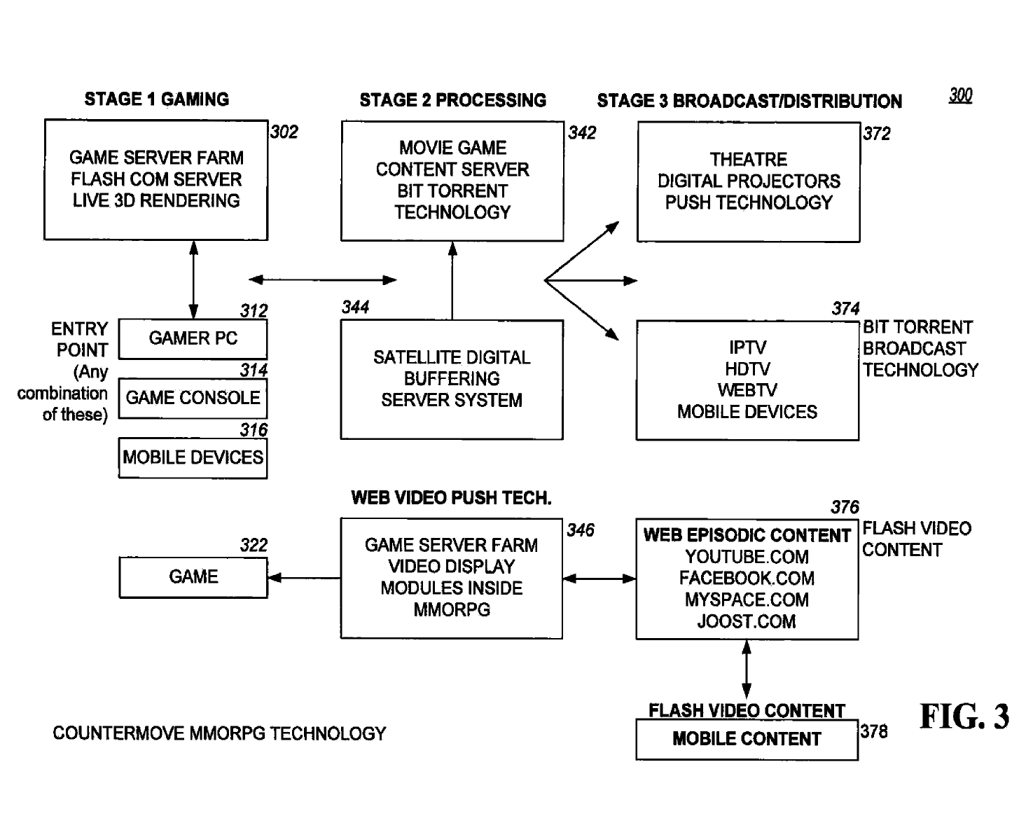

In FIG. 3, a pair of narrative creation structures 300 is illustrated. Both can be used either standalone or interchangeably within an overall story arc. The design of each narrative creation structure is cyclical in nature so that the arc can be adjusted to sequences of one or more live narrative events to create an ongoing epic saga if the narrative content. For example, a theatrical trilogy may be designed as an epic arc with interactive game play in between each release of the movie to drive the story line. Another example would be to have seasonal television episodes with interactive game play driving the story line of the episodes. The narratives in both scenarios can be controlled by the producers through the parameters of game play and mechanistic driving forces that can move the gaming community in the direction of where the story is designed to go for the next live narrative event.

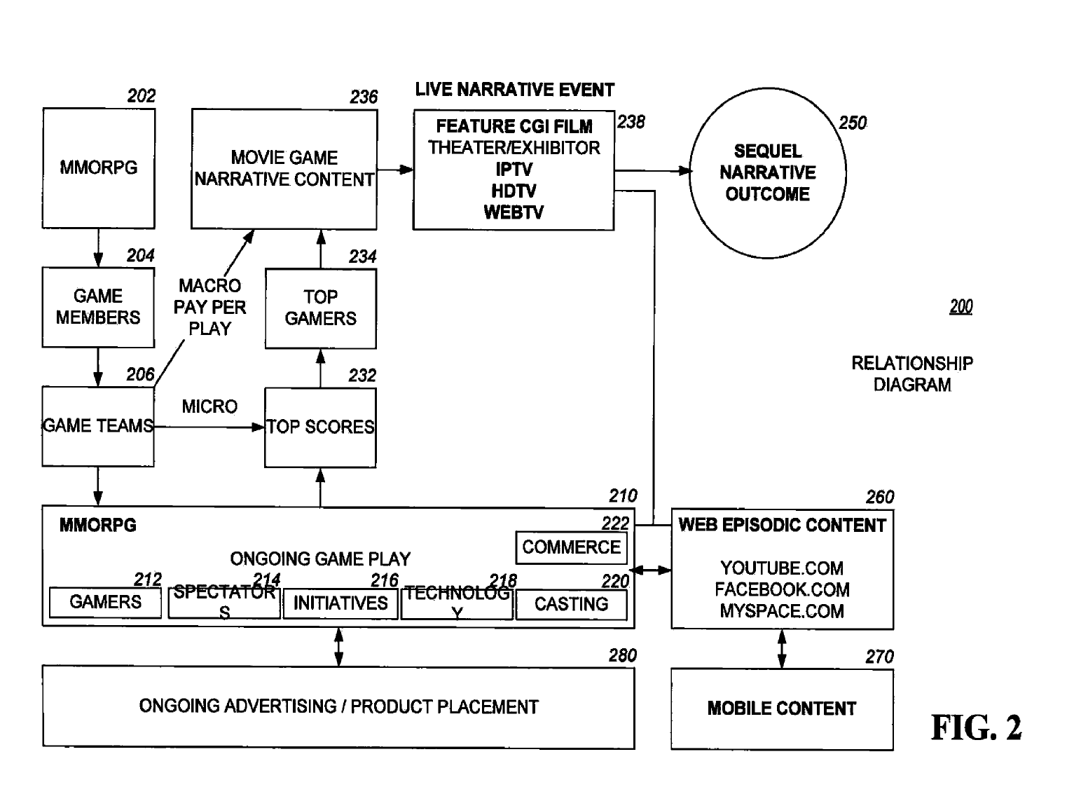

The first type of narrative structure, referred to and shown as Process A. This is an outcome determinant structure whereby the game play drives the narrative plot. Referring also to FIG. 2, which illustrates a relationship of the entities 200 in the system, the game players could be comprised of the “top players,” as described for a micro sequence that is defined further herein; or players that are part of an open event, as described by a macro sequence that is also defined further herein, as respectively illustrated in the figure. In this first scenario, game participants playing in the live narrative event can create two or more narrative outcomes based upon what happens in the game play. For example, if the CGI sequence incorporating game play is the final epic battle scene of a movie, if the protagonists win, then “Outcome A” in the narrative is the result; and vice-versa, if the antagonists win, then “Outcome B” of the narrative results. In either case, the actions of all MMOG players are recorded to a text log throughout the event, this detailed text log of the game participants' actions will be the basis of all future media generated from the participants' input. Depending on where the narrative is on the episodic story are, further game play may result. For example, the game play can send the winners to the next level of game play. Further, the losers may start over the current level, or the epic may end and spin off into a new story line.

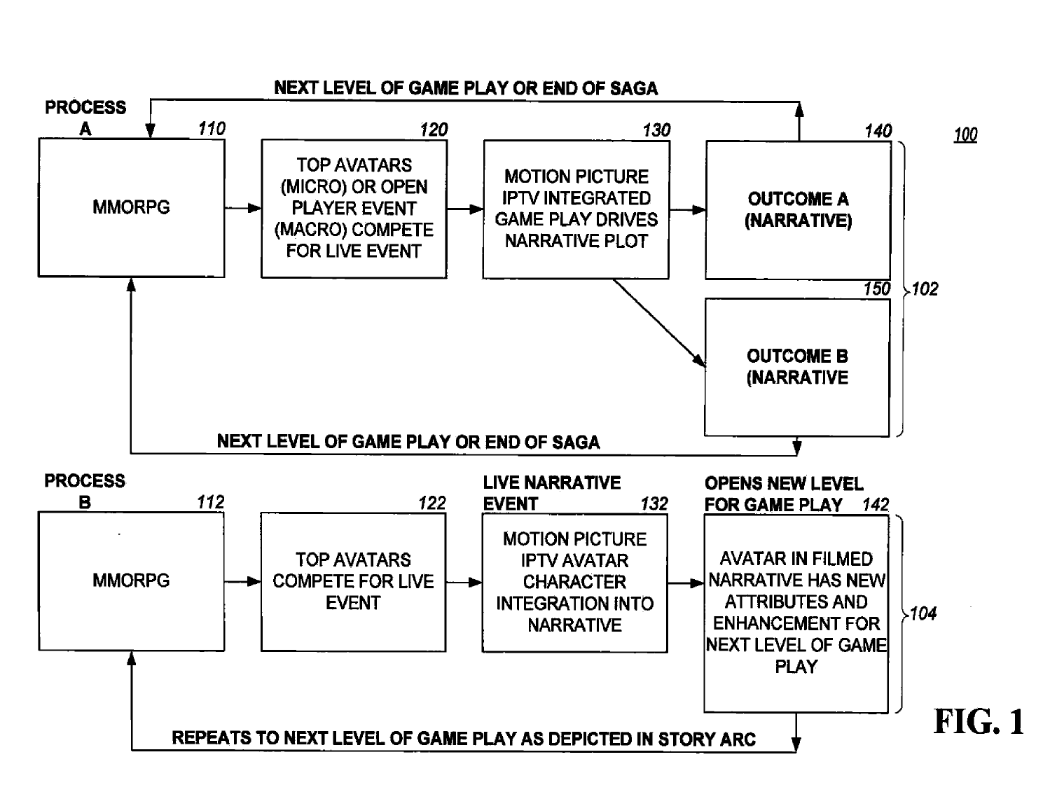

Continuing to refer to FIG. 1, the second type of narrative creation structure is illustrated and referred to as Process B. This is more of a reward system where the top players have their avatar be in the movie. Avatars can be in the movie with the outcome of enhancement to character features after the movie is released, where game play drives avatar participation in a live narrative event, but there is no live game play during the live narrative event. Process B is designed exclusively for the micro sequence, which is a depiction of a series of events within the narrative involving the avatars of top players of the MMOG, allowing players to compete for their avatars to be both cast as characters in the live narrative event and have enhanced features for game play after the release of the live narrative event. These avatars, referred to as “top avatars”, thus belong to the top players.

For example, avatars of the top players may be integrated through CGI rendering into scenes of the live narrative events and equipped/provided with equipment, character attribute enhancements or other benefits that they normally could not otherwise receive from game play. These enhancements will make these avatars a more valuable member of their gaming community and be treated like “champion” character. In an aspect, similar to Process A, the second type of narrative creation structure is cyclical so that the avatar can return to game play and the next level is opened to gamers to participate. Alternatively, a particular epic story arc may end with the point of avatar integration and game play will be launched into a new sequence, world or story line with a new arc.

The relationship between the various entities is comprised of three distinct sub-categories of interactive experience, as depicted in FIG. 2. These have been named the micro sequence, the macro sequence and the “combo sequence” for the sake of simplicity.

The micro sequence involves the delivery of a hero narrative, rewarding top participants (gamers) of the MMOG with an opportunity for their avatar to star in one or more live narrative events as a character written into the script. Essentially, gamers will be competing both through performance, game points, social recognition through an integrated social network, and other criteria set by producers of the interactive entertainment system to be ranked among the top players of the MMOG. In one exemplary embodiment, players may elect to be either “a protagonist” or “an antagonist” with the intent of creating two separate teams representing the competitive sides for competitive game play. Under the micro sequence, either the Process A or the Process B narrative creation structures may be used depending upon budget, the medium of narrative creation, and timing.

In the case of a Process A structure, the top players will be invited to participate in the live narrative event in which multiple teams will engage in live competition during specified scenes at the foreground of the narrative. The characters of the top players, represented by avatars, may live or die, or receive special rewards, advancement or other attributes for future game play depending on how the narrative is constructed by the producers. The live action could be streamed to mass audience distribution (in any or all media, such as through cinema) through buffered technology and rebroadcast, repurposed or redistributed as a live recorded event.

In the case of a Process B structure, the top players compete only to have their avatars depicted as minor characters within scenes of the live narrative event (albeit not outcome determinant) and they will only receive enhanced features or attributes as a reward. These features or advancement in game play occurring immediately after the live narrative event (it could be the initial release of the motion picture, television episode, webisode or mobisode, i.e., episodes played on mobile devices).

In one exemplary embodiment, the macro sequence allows any active MMOG players to participate in the live narrative event (either via a pay-per-play, sponsored or free basis) except that their competition or action cannot be viewed by the audience in detail. While the garners will be playing with a point of view (POV) of their avatar and a window of the live narrative event occurring at the same time, their avatar will not be discernable in detail and the outcome of the aggregate game play (involving all the players) will drive the story line. In this approach, the CGI rendering of the background of the battle scene (or the battle scene in general) does not discern any particular individual character in detail. The avatars of the players will be a part of the battle scene, but while no individual player may be able to pick their avatars out of the scene on the images that are being displayed in the theater; their avatar obviously are nonetheless having an impact on the battle. In another approach, the avatars of the players may be displayed in detail based on the control of a person (producer, audience, etc.), similar to how a movie may have a general action sequence, but the audience may be brought closer to the story for a particular character in the movie by the director focusing on that character even while the battle is occurring in the background. In one exemplary approach, the macro sequence would only be applicable with the Process A structure. In either of these exemplary approaches, the MMOG players' live actions can be streamed as video through buffered technology, or such video can be rebroadcast as a live recorded event. Alternately, the game server logs created as a result of the users' participation in the live narrative event can be re-rendered at a far higher quality for use in high definition media.

The combination (“combo”) sequence involves concurrent game play of both the macro and micro sequences. In essence, the top players will be in game play at the foreground of the narrative and the rest of the gaming community will be playing in the background. The combo sequence would be used in certain epic scenes such as final battles, chases or other types of typical “third act” conventions that work towards the resolution of the story plot.

In addition to the interactions listed above, the interactive entertainment system can incorporate social networking, integration with point system and charitable contributions, enables re-casting, e-commerce and integrated advertising and sponsorship.

FIG. 3 illustrates an interactive entertainment system 300 is driven from a distribution-centric platform in one aspect of the disclosure. The figure outlines the possible configuration and integration of various technologies now in existence in order to implement the distribution platform. The unique opportunity is developing the software that integrates dynamic input CGI in either foreground or background video rendering in real or close to real-time without compromising viewer experience or game play. Such integrated video can then be streamed through various means of distribution. Additionally, the players' dynamic input can be used in the form of server-generated text logs to render a far higher quality video by means of processing, resulting in a high definition video media with only a minimal time lag (or, in the future, none as the lag is a function of raw computational power).

FIG. 3 is described based on a grouping of three (3) stages: Gaming; Processing, and Broadcast/Distribution.

Stage 1: Gaming.

Stage 1 essentially starts from the initial input or point of entry for user-generated content, which comes from players' game-play participation. The technology will be able to accept any or all existing network-enabled hardware devices (or any such devices developed in the future) and from different location based initiating points, as all game interactions are conducted through, in one aspect of the disclosure, the Internet (TCP/IP protocol). For example, participants can participate in the live narrative event through their personal computers, set top boxes, gaming consoles and mobile devices. These devices will connect to a game server farm server with rendering serving the movements and action of avatars. The game server farm provides the players with the game world and arbitrates all of the players' actions within the game. The players' gaming devices render the game world for the use of the respective players (the renderings may be of different quality on different hardware devices). The game server farm protocols the actions of each player at the finest possible granularity in a text log (e.g., players' positions, actions, equipment, movement, etc.) and at the same time produces a live 3D rendering that can be directly broadcast. In one aspect of the disclosure, the rendering may be a composite of the game's narrative with an existing foreground/background. The text logs are available for further processing (e.g. high definition processing, model replacement, etc.).

In addition, the following three (3) components will be used in the interactive entertainment system:

(a) Enhanced CGI: In an exemplary embodiment, the CGI rendering software of the interactive entertainment system will enable the integration of dynamic CGI into an existing video stream, either in the background or foreground) using a series of overlays and blue screen technologies to integrate user generated content in real time.

(b) Mobile Gaming Controllers: The live narrative events (particularly at a location-based participation such as a movie theater) could include audience participation through traditional game controllers or even mobile devices with a downloadable software client that turns mobile devices into game controllers. In an exemplary embodiment, controllers may be based on 3G or Wi-fi enabled technologies that can communicate to a location-based server (or servers) during live game play. Controllers also comprise of a code-encrypted participation key for MMOG participants to enter at the commencement of the live narrative event, which can be sent via SMS to the participant, streamed to the screen through the server, or uploaded through the location based-server to the mobile device in order to unlock mobile device game controller capabilities. This increases security for the participants and ensures that each participant is actually a member of the MMOG community.

(c) Delivery and Deployment System: This hybrid distribution system will be dependant on a combination of deployment technologies and as new such deployment technologies are developed, some components of the delivery and deployment system may be replaced by more modern modules providing identical features but faster technologies. The unique deployment system, in one aspect of the disclosure, uses bit torrent server-side technologies integrated with game servers and video servers to combine dynamic real-time buffering and digital video delivery that integrates with live gaming technologies. It should noted that any other distribution technology that satisfies the quality of service and timeliness requirements may be used.

Stage 2: Processing.

Stage 2 of FIG. 3 is the processing, buffering and serving component of the live action event. In one exemplary embodiment, the live narrative event will be broadcasted to active gaming participants in real time via such distribution technologies as bit torrent technologies and to passive audience members through a buffered server system. This ensures that the bandwidth capacity to passive viewers is sufficient for a fully integrated viewing experience. The gaining participants in the live narrative events will have the ability to switch between the POV of game play and the streaming of the live narrative event in real time. In one exemplary approach, in a micro-sequence each team will be located in separate areas (e.g., buildings or theaters). Certain players may also be located “off-site”. On a macro sequence, the players would be using their own computer or other device.

Additionally, the processing stage can be used to perform any kind of computationally intensive modification or integration of the game participants' actions. The results of such additional processing can be made available by incurring a slight time lag (as processing for some transformations will incur a time penalty), but with the further increase of computational power such lags should be negligible in the near future. In an exemplary embodiment of such additional processing, the raw text log files from the game server could be used to reconstitute the game scene and action using character models and scene settings of a far higher polygon count resolution than possible within the game in real time. Such high-polygon environments would additionally allow a movie's director to predefine moving cameras, make changes in a scene's lighting, impose alterations to characters' movements, etc. and, once rendered, would result in maximum quality movie footage meeting even the most demanding applications (hi-def theater streaming, blue ray discs).

Stage 3: Broadcast/Distribution.

Stage 3 uses a streaming distribution infrastructure to stream buffered content to local content delivery networks that then, in turn, stream the content to local carrier or venue servers (e.g., movie theaters). The content is then pushed to digital projectors for theatrical release, to television via IPTV, HDTV, WebTV and mobile devices. Content is recorded and can be redistributed and syndicated for continued theatrical release, television, DVD, webisode, mobile or through any other media after the live narrative event. If additional processing has been used in Step 2, a slight lag may be incurred before the initial content push happens. Recorded content (whether it is in the form of recorded video or the result of processing the game servers' logs) can be further enhanced and modified through Step 2 processing before it is distributed.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal. Moreover, in some aspects any suitable computer-program product may comprise a computer-readable medium comprising codes (e.g., executable by at least one computer) relating to one or more of the aspects of the disclosure. In some aspects a computer program product may comprise packaging materials.

The teachings herein may be incorporated into (e.g., implemented within or performed by) a variety of apparatuses (e.g., devices). Accordingly, one or more aspects taught herein may be incorporated into a computer (e.g., a laptop), a portable communication device, an image processing system (e.g., a radar or photo image processing system), a portable computing device (e.g., a personal data assistant), a phone (e.g., a cellular phone or smart phone), a global positioning system device, or any other suitable device that is configured to perform image processing.

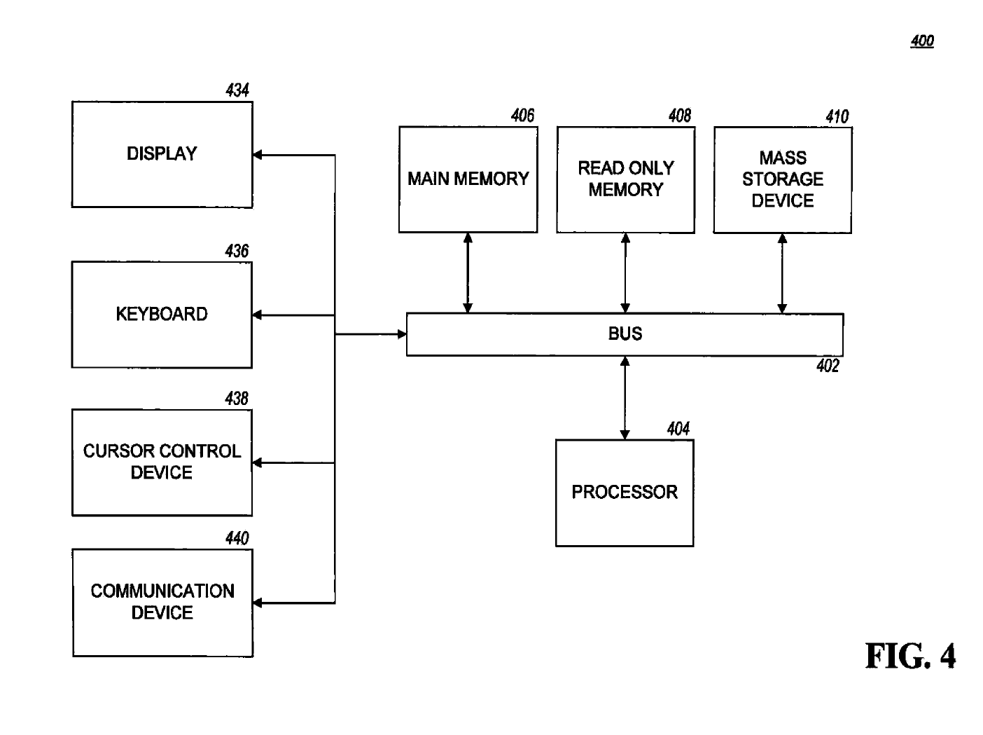

FIG. 4 illustrates an example of a computer system 400 in which certain features of the exemplary interactive entertainment and competition system may be implemented. Computer system 400 includes a bus 402 for communicating information between the components in computer system 400, and a processor 404 coupled with bus 402 for executing software code, or instructions, and processing information. Computer system 400 further comprises a main memory 406, which may be implemented using random access memory (RAM) and/or other random memory storage device, coupled to bus 402 for storing information and instructions to be executed by processor 404. Main memory 406 also may be used for storing temporary variables or other intermediate information during execution of instructions by processor 404. Computer system 400 also includes a read only memory (ROM) 408 and/or other static storage device coupled to bus 402 for storing static information and instructions for processor 404.

Further, a mass storage device 410, such as a magnetic disk drive and/or a optical disk drive, may be coupled to computer system 400 for storing information and instructions. Computer system 400 can also be coupled via bus 402 to a display device 434, such as a cathode ray tube (CRT) or a liquid crystal display (LCD), for displaying information to a user so that, for example, graphical or textual information may be presented to the user on display device 434. Typically, an alphanumeric input device 436, including alphanumeric and other keys, is coupled to bus 402 for communicating information and/or user commands to processor 404. Another type of user input device shown in the figure is a cursor control device 438, such as a conventional mouse, touch mouse, trackball, track pad or other type of cursor direction key for communicating direction information and command selection to processor 404 and for controlling movement of a cursor on display 434. Various types of input devices, including, but not limited to, the input devices described herein unless otherwise noted, allow the user to provide command or input to computer system 400. For example, in the various descriptions contained herein, reference may be made to a user “selecting,” “clicking,” or “inputting,” and any grammatical variations thereof, one or more items in a user interface. These should be understood to mean that the user is using one or more input devices to accomplish the input. Although not illustrated, computer system 400 may optionally include such devices as a video camera, speakers, a sound card, or many other conventional computer peripheral options.

A communication device 440 is also coupled to bus 402 for accessing other computer systems or networked devices, as described below. Communication device 440 may include a modem, a network interface card, or other well-known interface devices, such as those used for interfacing with Ethernet, Token-ring, or other types of networks. In this manner, computer system 400 may be coupled to a number of other computer systems.

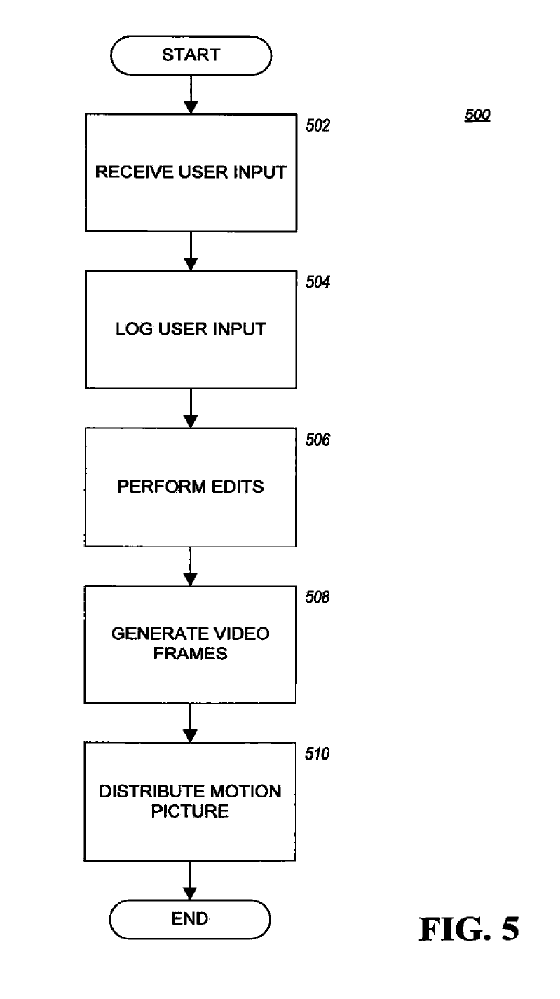

FIG. 5 illustrates an interactive entertainment and competition algorithm 500 that, in one aspect of the disclosure, is implemented on a server or a server farm. The algorithm 500 starts with a step 502 for receiving user inputs from a plurality of participants in an interactive entertainment and competition system.

The user inputs are logged in step 504 using any suitable database system that can be stored on a mass storage device such as the mass storage device 410. In one aspect, the plurality of user inputs is logged in a time-based fashion, where snapshots of the user inputs are stored with an associated time. In other aspects, state information about the user can be stored as well as user input.

In step 506, an edit is performed such that a rendering can be made from the logs based on the edits. Various editorial decisions may be made, such as camera angles, compositing, lighting, and other renderable features. As the virtual world can be constructed from any angle, perspective, and size, the editorial decisions can be as flexible as the rendering engine used.

In step 508, video frames are generated from a rendering based on the editorial decisions in the previous step. Several levels of renderings could occur, either in parallel or sequentially. For example, a high level of detail would require rendering resources that is significantly more than the rendering resources needed for a quick rendering. However, a quick rendering, or several quick renderings-each from a different angle, can be used. Then, an editor or director can select from the different quick renders to produce the final detailed rendering. The final detailed rendering can include segments from the different quick renderings or the final detailed renderings.

In step 510, the motion picture, assembled from the renderings produced before, can be distributed using the distribution network technology as discussed herein.

The various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the present disclosure. Thus, the present disclosure is not intended to be limited to the aspects shown herein but is to be accorded the widest scope consistent with the principles and novel features disclosed herein.

1-19. (canceled)

20. A method for creating a real-time motion picture using a real-time game system, comprising:
providing an underlying narrative and environment for a motion picture;
receiving a plurality of inputs from participants in the real-time game system;
storing the plurality of inputs in a time-based manner;
generating a plurality of video frames based on the time-based storage of the plurality of inputs;
producing a real-time rendering of the motion picture based on the plurality of video frames; and
directly broadcasting, in real-time, the motion picture to an audience that includes individuals who are not participants.

21. The method of claim 20, wherein the plurality of inputs are stored in the form of text logs that represent at least one of the following: a participant's position, a participant's actions, a participant's movement, and equipment in the motion picture environment.

22. The method of claim 20, wherein the text logs are further processed to provide high definition video frames.

23. The method of claim 20, wherein the time-based manner is a high-frequency manner.

24. The method of claim 20, wherein the storage comprises tracking state information based on the plurality of inputs on a predetermined periodic basis.

25. The method of claim 24, wherein the state information includes a time association.

26. The method of claim 20, wherein the storage comprises creating a log from the plurality of inputs.

27. The method of claim 20, wherein the generation comprises performing an edit comprising selecting at least one of a camera position; a lighting; and a compositing function.

28. The method of claim 20, wherein the rendering comprises at least one of two levels of quality of rendering.

29. The method of claim 20, wherein the broadcasting includes broadcasting to individuals at different remote locations.
